(19) United States
(12) Patent Application Publication
(10) Pub. No.: US 2010/0026517 A1
(43) Pub. Date: Feb. 4, 2010

(54) UTILITY DATA COLLECTION AND RECONFIGURATIONS IN A UTILITY METERING SYSTEM

(75) Inventors: Scott Cumeralto, Spokane, WA (US); Matthew Johnson, Spokane, WA (US); Mark K. Cornwall, Spokane, WA (US); Fabrice Monier, Bry Sur Marne (FR); Gilles Picard, Thiais (FR); Arnaud Clave, Paris (FR); Hartman Van Wyk, Mont Louis Sur Loire (FR)

Correspondence Address: DORITY & MANNING, P.A., POST OFFICE BOX 1449, GREENVILLE, SC, 29602-1449, US

(73) Assignee: Itron, Inc., Liberty Lake, WA (US)

(21) Appl. No.: 12/495,922

(22) Filed: Jul. 1, 2009

(30) Foreign Application Priority Data
Jan. 4, 2008 (US) PCT/US2008/050310

(51) Int. Cl. G08C 15/06

(52) U.S. Cl. 340/870.03; 340/870.02

(57) ABSTRACT

A one-and two-way wireless data collection system for a utility metering environment includes multiple endpoints with wireless transceivers, and a collector with transceiver for communicating with the endpoints.

### PRIORITY CLAIM

This application claims the benefit of previously filed U.S. Provisional Patent Application entitled “Mobile Demand Reset,” assigned U.S. Ser. No. 60/883,490, filed Jan. 4, 2007, and claims the benefit of previously filed PCT International Patent Application entitled “Utility Data Collection and Reconfigurations in a Utility Metering System,” assigned International Application No. PCT/US2008/050310, and International Filing Date Jan. 4, 2008, and which are both incorporated herein by reference for all purposes.

### BACKGROUND

Five to ten percent of electric utility meters are installed on what are known as C&I (Commercial and Industrial) accounts, which often have large-scale power needs. The utility meters installed on such C&i accounts are typically more sophisticated than the basic residential watt-hour meter. For example, these meters may measure more parameters than simple watt-hour consumption, including time of use (TOU) and demand values that represent the highest, or peak, power demand over a unit of time. Typically, such demand data is accumulated over a billing cycle that is approximately one month in length. Accordingly, as part of collecting consumption, demand, and TOU data, it is desirable for a utility to be able to reset a meter (particularly the demand value) after information collection takes place, which typically occurs once every billing cycle.

In many of today's systems, the demand value at a meter is reset by: physically depressing a switch button on the meter, initiating a reset function from a handheld or laptop computer via a serial optical probe and serial data connection, or using an automatic timer or calendar feature that is programmed into the meter. In such systems, recognition of the reset event is not provided proof-positive to the meter reader and inference rules must be applied. This impacts the business rules of many utilities and is not desirable. In addition, some of these approaches disconnect the demand reset from the meter read and results in a mismatch of timestamps that is not favored by utilities.

Other systems may allow a demand reset command to be sent to a meter/endpoint device (e.g., via a radio transmission) but do not provide any confirmation that the command was received and executed, resulting in erroneous readings and, ultimately, an unreliable system. Some of the possible undesirable scenarios that might occur in such systems include the following: (a) a data collector sends multiple demand reset requests (in order-to ensure that reset occurs) and peak demand is inadvertently reset more than once during a short time period, which causes the loss of peak demand information between readings; and (b) a demand reading transmission from meter/endpoint to collector fails and the meter reader receives incomplete data or no data at all, requiring repeated transmission attempts, which is highly inefficient. In a mobile collection or reading environment, such inefficiency can be compounded by further retransmissions to subsequent end points due to the short time the mobile is in optimal range of the end point.

Readings of peak demand information, consumption information, TOU information, and/or other meter-related data are typically made over a serial data connection from a handheld or laptop computer with an attached serial optical probe, which queries various data storage components (e.g., ANSI C 12.19 registers) in the meter to obtain and calculate the desired readings for the utility. Such readings may also be made via radio transmission sent from a meter/endpoint and collected by some type of radio enabled collector system/device. However, there is often the concern that such transmissions may be at least partially unsuccessful and may need to be repeated.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### SUMMARY

The present subject matter relates generally to utility data collection, and more specifically to collection of various data types and management of such collections, from endpoints, such as utility meters.

More particularly, the present subject matter in some embodiments relates to a plurality of electricity meters, which interact with a reader, in some instances such as a mobile device, for collection of various utility data types and/or for resetting of registers and/or other instructions provided back to such endpoints.

One present exemplary embodiment relates to a method of assessing or predicting communication reliability for an automatic meter reading system comprising at least one reader and a plurality of endpoints, each of the endpoints adapted to conduct radio frequency communication with one of the at least one reader on a bubble-up basis in a one-way mode, and in a selectively-initiated two-way mode. Such exemplary method preferably comprises receiving a message transmitted between a first reader and a first endpoint; measuring a received signal strength indication (RSSI) of the message; and making a decision affecting future communication between the first reader and the first endpoint based on the measured RSSI.

In variations of such method, the step of receiving the message may include either receiving the message from the first endpoint by the first reader, or receiving the message from the first reader by the first endpoint. The step of receiving the message may also include receiving the message in the one-way mode or in the two-way mode.

In other variations, the step of making the decision affecting future communication between the first reader and the first endpoint may include foregoing initiating or continuing two-way communications. Alternatively, such may include adjusting an instruction specifying a request for certain data to be transmitted in the two-way mode. Further, it may include transmitting a command in two-way mode to change channels. Still further, it may include changing a mobile collection route or schedule. Alternatively, it may include assigning the first endpoint to a second, different, reader. Yet further, such may include instructing the first endpoint to increase transmission power level.

In another exemplary alternative, such method may further include the steps of logging RSSI values associated with certain communications; and analyzing the logged RSSI values to identify a potential trend or characteristic of a communication arrangement between the first reader and the first endpoint.

Another present exemplary embodiment relates to a method of improving communication reliability in an automatic meter reading system comprising a reader and a plurality of endpoints, each of the endpoints adapted to conduct radio frequency communication with the reader on a bubble-up basis. Such method preferably includes receiving, by the reader, a first message transmitted by a first endpoint at a first frequency; determining, by the reader, whether the first frequency is suitably centered within a predefined communication channel associated with the first message; initiating two-way communication between the reader the first endpoint; and during the two-way communication, sending an instruction to the endpoint from the reader, wherein the instruction specifies a frequency correction for the endpoint to implement.

In a yet further present exemplary embodiment, a method of assessing or predicting communication reliability is provided in an automatic meter reading system comprising at least one reader and a plurality of endpoints, each of the endpoints adapted to conduct radio frequency communication with one of the at least one reader on a bubble-up basis in a one-way mode, and in a selectively-initiated two-way mode. Such exemplary method preferably comprises measuring channel clarity; and making a decision affecting future communication between a first reader and a first endpoint based on the measured channel clarity.

Another present exemplary method of conducting communications is for practice in an automatic meter reading system that includes a reader and a plurality of endpoints, each of the plurality of endpoints adapted to conduct radio frequency communication with the reader. Such method preferably comprises the steps of initiating, by the plurality of endpoints, a communication session with the reader via an initial one-way communication comprising an identification beacon of the endpoint; and selectively initiating, by the reader, two-way communication with individual ones of the plurality of endpoints in response to receipt of an initial one-way communication from each of such endpoints.

The foregoing method may further comprise the step of automatically synchronizing with the reader communication activity of each of the individual ones of the plurality of endpoints with which the reader selectively communicates in two-way mode. In yet another present alternative of the foregoing, such method may further include selectively transmitting from the reader to an endpoint an instruction that includes a command requesting a set of consumption information from such endpoint; and operating such endpoint to respond to such command by transmitting a message that includes the requested consumption information. In other present alternatives, such method may further include maintaining a database by the reader, the database including endpoint-specific information associated with each of the plurality of endpoints. Another present variation may further comprise simultaneously receiving two-way communications from endpoints transmitting on different channels.

In another present variation of the foregoing exemplary embodiment, the method may further include configuring such reader to selectively transmit commands to an endpoint selected from: a command to send time of use data, a command to send consumption data, and a command to reset registers.

In yet a further present variation, such plurality of endpoints may comprise a respective plurality of electric meters with respective data storage registers for storing consumption data, respective clocks to maintain time, and respective radio systems for communication with such reader; wherein such reader may include a computer, GPS, mapping and meter reading software and radio receivers and transceivers for communicating with such meters; and such meters and such reader may be re collectively capable of operating both in synchronized and non-synchronized modes.

Further, such meters may alternatively respectively transmit a meter beacon signal periodically and thereafter listen for a preset period of time on the same frequency as the previously sent meter beacon signal; and such reader may return a reader beacon signal on the same frequency.

In other present variations, such meters may respectively synchronize themselves with such reader upon respective receipt of such reader beacon signal; and such meters may respectively include acknowledgement information in the headers of subsequent messages from the meter once the meter is synchronized with such reader. Further, such exemplary reader beacon signal may include a frequency channel assignment to which the respective meter is to switch; and each respective meter upon receipt of such reader beacon signal may set a timer after which it will return to a non-synchronized mode. Still further, such reader may automatically handle duplicative transmissions from such meters. Also, such meters and such reader when conducting two-way communications in synchronized mode, may address lost messages by repeating a message once on such assigned frequency channel, and if no answer, a second time on an alternate channel.

It is to be understood by those of ordinary skill in the art that the present subject matter equally relates both to methodology, and to corresponding apparatus or devices for practice of such methodology. One present exemplary embodiment relates to a mobile daily interval meter reading system, comprising an endpoint and a reader. In such system, preferably such endpoint is capable of transmitting in either one-way or two-way RF communication mode, saves a plurality of intervals of utility meter data, and normally operates in a bubble-up mode using such one-way RF communication mode; and such reader listens for such endpoint in such bubble-up mode, and upon detecting such endpoint in such bubble-up mode, utilizes such two-way RF communication mode to transmit a command to such endpoint to send a specified number of intervals in response.

In such exemplary system, such reader may be configured to selectively transmit commands to such endpoint, selected from: a command to send time of use data, a command to send consumption data, and a command to reset registers. Also, such system may further include a plurality of such endpoints, comprising a respective plurality of electric meters with respective data storage registers for storing consumption data, respective clocks to maintain time, and respective radio systems for communication with such reader; and wherein such reader may include a computer, GPS, mapping and meter reading software and radio receivers and transceivers for communicating with such meters, such meters and such reader collectively capable of operating both in synchronized and non-synchronized modes.

In alternatives of the foregoing exemplary system, respectively such meters may periodically transmit a meter beacon signal and thereafter listen for a preset period of time on the same frequency as the previously sent meter beacon signal; and such reader may return a reader beacon signal on the same frequency. Still further, such meters may respectively synchronize themselves with such reader upon respective receipt of such reader beacon signal. Also, such meters may respectively include acknowledgement information in the headers of subsequent messages from the meter once the meter is synchronized with such reader.

In other present variations of the foregoing, such reader beacon signal may include a frequency channel assignment to which the respective meter is to switch; and each respective meter upon receipt of such reader beacon signal may set a timer after which it will return to a non-synchronized mode. Further, such reader may include multiple receivers able to simultaneously receive multiple frequencies from multiple meters. Also, such reader may automatically handle repetitive transmissions from such meters. Still further, such meters and such reader when conducting two-way communications in synchronized mode, may address lost messages by repeating a message once on such assigned frequency channel, and if no answer, a second time on an alternate channel.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the present subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

FIG. 1 is a schematic diagram of a mobile collection system showing a mobile collector and multiple meters/endpoints having both one-way and two-way wireless connectivity;

FIG. 2A is a block diagram showing an example of a mobile collector and a two-way meter/endpoint, which employ aspects of the invention;

FIG. 2B is a block diagram showing a more detailed view of the data storage at the meter/endpoint shown in FIG. 2A;

FIGS. 3A and 3B show a sample implementation using a RF to Net or “RF2Net” protocol;

FIG. 4 is a message exchange diagram showing an exchange of message between a mobile collector and two end points EP1 and EP2;

FIG. 5 is a block diagram of the software layers; and

FIG. 6 is a state diagram with messaging showing Idle, Synchronized and Non Synchronized Modes.

Repeat use of reference characters throughout the present specification and appended drawings is intended to represent same or analogous features, elements, or steps of the present subject matter.

### DETAILED DESCRIPTION

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

### Representative System

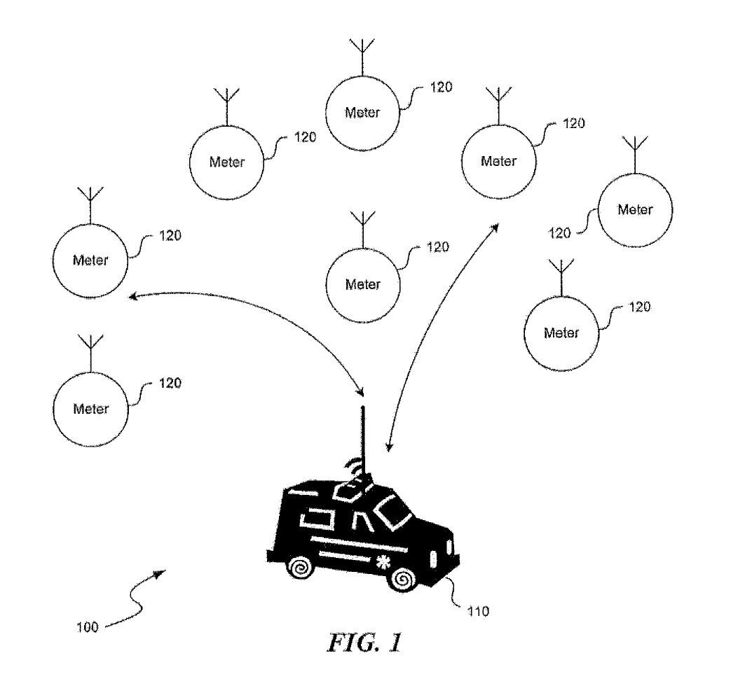

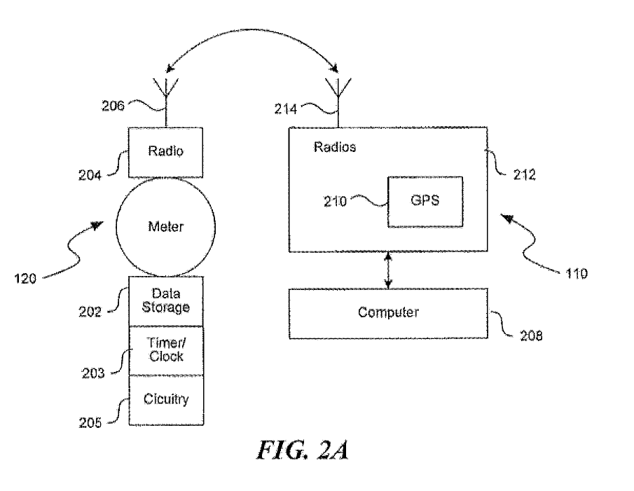

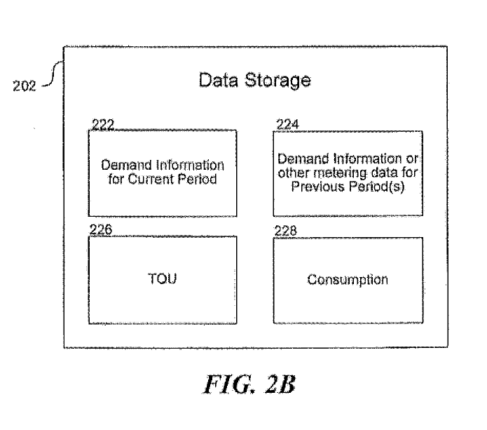

FIGS. 1, 2A, 2B and the following discussion provide a brief, general description of a suitable environment in which aspects of the invention can be implemented. Although not required, aspects and embodiments of the invention will be described in the general context of radio communications and/or computer-executable instructions, such as routines executed by a general-purpose computer, e.g., a server or personal computer. Those skilled in the relevant art will appreciate that the invention can be practiced with other system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. Aspects of the invention can be embodied in a special purpose computer or data processor or by using other circuitry that is specifically programmed, configured or constructed to perform one or more of the activities explained in detail below. Indeed, the term “computer”, as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

More specifically, FIGS. 1 and 2A show aspects of a sample utility data collection environment 100 in which a collection system/device 110 can be used to collect utility data (e.g., consumption data, time of use (TOU) data, peak demand data, etc.) from one or more remotely located meters/endpoints 120 using radio-based mobile/remote techniques. (The terms “meter” and “endpoint” are generally used interchangeably herein, as are the terms “collection system”, “collector”, “reader” and “drive-by unit”.) In the case where the one or more of the meters/endpoints 120 is associated with a C&I account, the system of FIGS. 1 and 2A allows a demand reset function to be initiated via radio, for example, while the collection system/device 110 is collecting reads (e.g., from other meters on a meter route). In general, however, while performing the meter reading route, the collection system/device 110 may coordinate the reading of one-way meters with the two-way demand reset meters seamlessly to maintain the high read reliability the utility has come to expect from reading just one-way meters.

While a vehicle based collection system 110 is illustrated in FIG. 1, various types of reader devices may be used (either alone or in combination) to implement the collection system/device 110. These include but are not limited to a handheld mobile reader, a fixed remote reader, etc.

As illustrated in FIG. 2A, a representative meter/endpoint 120 of the collection environment 100 includes a data storage component 202, a timer and/or clock 203 (optional), a radio module 204, basic circuitry 205, and an antenna 206. In addition to allowing the meter 120 to track time-of-use data related to consumption of the utility, the timer and/or clock 203 may allow the meter 120 to perform functions such as setting a demand reset hold-off. The basic circuitry 205 within the meter 120 may be analog and/or digital circuitry that allows the meter/endpoint to perform functions such as switching from a bubble-up (one-way) mode of communication to a two-way mode of communication, preparing/formatting packets of requested data to send out to the collection system/device 110, clearing, setting, and resetting registers of the data storage component 202 as appropriate (e.g., satisfying a demand reset request), setting and operating timers (e.g., performing a time sync operation, setting a demand reset hold-off timer, etc.), interfacing with the radio module 204, etc. The complexity of the circuitry 205 within respective meters 120 of the utility data collection environment 100 may vary based on the type of account (e.g., residential versus commercial) and other factors (e.g., one-way only or two-way, etc.).

The collection system/device 110 comprises at least one computer 208 having one or more processors, a GPS module, and at least one radio receiver/transceiver 212 that communicate with the meters 120 via an antenna 214 using one-way and/or two way radio communications. Various radio communication/modulation schemes may be used to facilitate RF communications between the meters 120 and the collection system/device 110. These may include a single channel high speed FM link, on-off key (OOK) transmissions (which may improve uplink performance for long packets of data), frequency-shift keying (FSK), or other high speed radio links. Note that a GPS module is not required, but any other device or method may be employed. For example, any source of precision time in the reader for resetting clocks in the meters may be employed; GPS is just one suitable method of implementation.

The computer 208 of the collection system/device may have mapping and/or meter reading software installed upon it, as well as an associated operating system. The collection system 110 (e.g., via its computer 208 or other features) may allow for user interaction via one or more input/output devices (e.g., screen, keyboard, touch pad, mouse/pointing device, microphone, joystick, pen, game pad, scanner, digital camera, video camera, printer, plotter, speakers, tactile or olfactory output devices, etc.). The collection system 110 (e.g., via its computer 208 or other features) may optionally be coupled to external systems/computers via a network connection, wireless transceiver, etc. Accordingly the computer 208 may include features such as a connection port to a network such as a local area network (LAN), wide area network (WAN) or the Internet.

FIG. 2B shows a more detailed view of the data storage component 202 of the system. The data storage 202 component may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMS, ROMs, smart cards, etc.

The data storage component 202 may be configured, for example, as multiple registers, or in other storage configurations. In the illustrated embodiment, the data storage component 202 is configured using a first storage subcomponent 222 for storing demand information for a current time period (e.g., the time period beginning immediately following the most recently executed demand reset) and a second storage subcomponent 224 for storing demand information for one or more previous periods (e.g., a time period ending immediately before the most recently executed demand reset, and possibly previous time periods). In addition, the data storage component 202 includes a TOU storage subcomponent 226 to store time of use data and one or more additional storage subcomponents 228 to store consumption data. The data storage component thus may store multiple pieces of data, any of which may be provided to the collection system. Thus, the meter/endpoint may transmit for storage at the collection system 110 previous demand alone, and/or other data, such as previous TOU, etc.

The arrangement of the storage component 202 and subcomponents 222, 224, 226 and 228 of FIG. 2B is intended to illustrate, generally, the types of information stored at the meter/endpoint 120. Certainly, the technology described herein may be implemented using other data storage configurations including storage configurations that comply with industry standards, such as the ANSI C 12.19 standard for TOU and Demand meters, which is a standard commonly used in the United States. The C 12.19 Demand Reset/TOU register typically stores various reading-related parameters in sets of registers. The radio module in the meter takes the desired readings from these sets of registers and packetizes them for transmission to the reader/collector. The register may also contain serial interfaces to connect to external computers as well as the radio module. The C 12.19 Demand Reset/TOU register typically includes a battery-backed clock for maintaining time which is used to capture time-related meter readings. The register can also maintain a calendar that is used to close out demand periods by performing a demand reset based on a schedule in the calendar. Since the serial data rate to most TOU registers is quite slow, and multiple registers may need to be manipulated mathematically to obtain the desired reading, the radio may periodically download this information from the register and cache it, so that the two-way radio transaction will be faster.

### Communication Flows

The sample system described above with respect to FIGS. 1 and 2A and 2B may use a two-way protocol (e.g., the RF2Net Protocol) to implement its demand read and/or reset functionality. Of course, other messages or protocols may be employed, such as a combination of standard length consumption messages, variable length messages, and so forth, which provide a migration path from traditional equipment and protocols, and/or for optionally employing Bluetooth, Zigbee or WIFI protocols modified for vehicular operation. Traditionally these commercially available protocols may not be viable for fast moving mobile operation due to excessive acquisition time, signaling performance in a fading environment and typical RF power limitations. However, any wireless protocol may be employed with aspects of the systems described herein.

A successful read and demand reset communication flow begins with a bubble-up or one-way message transmitted from an endpoint, which is intended for receipt by the reader and which can contain minimum necessary information typically needed for a meter reading function. The information may include endpoint Identification number, tamper flag information, consumption information and check sum or other validation data. The start of two-way communications between the endpoint and the reader next begins, where the reader sends a packet containing a data request alone or with a demand- reset command. In response to successfully receiving the communication, the endpoint send out a demand read packet containing peak demand information and performs a demand reset. Thereafter, it is assumed that the two-point communication session is completed successfully, and accordingly, the endpoint reinstates a standard bubble-up interval.

The end point/meter meter may include a hold-off timer started shortly following receipt, from the reader, of a packet containing, for example, a demand reset command. If the packet containing the requested demand information is lost or otherwise not received by reader, then the setting of the hold-off timer prevents a subsequently received demand reset command from being executed at the endpoint while the hold-off timer is still running. For example, after realizing that it has yet to receive the requested demand data, the reader (which, in the case of a mobile collection system, may still be performing a driving route around the area of the endpoint) may send a duplicate demand reset communication under the assumption that the first demand reset packet was not received at the endpoint. If it were not for the setting of the hold-off timer, the endpoint would perform a second demand reset, even though it had just performed a demand reset just seconds (or minutes) before. Undesirably, these back to back demand resets if left to occur, may result in the creation of a very short demand interval that is inconsistent with the regular billing cycle period. Thus, the demand reset hold-off timer functionality prevents the creation of an inadvertent, short demand interval, and therefore preserves the integrity of the system.

An example of a suitable demand reset hold-off period might be 24 hours so that the likelihood of the reader resetting the meter more than once while driving a route for the day will be eliminated. While the hold-off timer is described in this example, the system may implement other timer related processes, such as time-stamping transactions and comparing them to one or more time stamps of the last transaction and the meter's clock to determine whether a message was received within or outside of a hold-off period. In some embodiments, the hold-off can be programmed over-the-air (OTA) from the collector where adjustments are required after the meter has been deployed (with no special trip or programmer required). Of course, the system may employ other types of OTA programming, such as correcting the meter's clock, changing TOU schedules, configuration programming of register(s), changing data stored or associated with other registers, etc. In addition to setting the hold-off timer, the meter/endpoint may flag if there were any subsequent unexecuted resets so that follow-up action may be taken if necessary. For example, the flagging of such an event and a related indication sent to the driver or operator of the reader/collector may indicate the need for a drive or walk by in case that problem exists.

In addition to the various aspects of the system that are described herein, the system may optionally or alternatively include other aspects that allow for the successful transmission of demand or other data and/or successful demand reset or other reconfiguration. For example, in some embodiments, the data from multiple registers in the meter may be structured in sub-packets with individual error detection and acknowledgements (ACK mapping) to minimize the amount of data required to be retransmitted if a packet collision occurs. Likewise, in some embodiments, diversity reception may be used to improve reception during RF fading conditions to minimize retransmissions. In the case of electric meters (which do not have the battery constraints of gas and water meters) the meter's receiver might be turned on multiple times or continuously between the meter's bubble-up transmissions to increase the availability of the meter to do two-way communications. In some embodiments, non-ISM band radio frequencies may be utilized for downlink communications (from the collector to the meter). The use of another non ISM-frequency may help to minimize lost reception time due to in-band transmission from the collector. This could facilitate performing additional communication sessions (e.g., using the ANSI C 12.19 communication standard) to interrogate additional registers to meet special reading or programming needs without special visits to the meter, although it might require the reader to stop briefly to perform the longer set of transactions. In such a case, the system may provide some sort of indication to the operator/user of the reader/collector.

In addition to the hold-off timer, or as an alternative to it, the meter may transmit its data, the collector tells the meter it has received the data, and then an acknowledgement (Awk) is provided to confirm a reset is now possible because the meter knows that the collector has received the data. Alternatively or additionally, the system may exchange sequence counters (or the meter may provide a sequence known to the collector) for the reset, where the collector knows a previous sequence counter (e.g. last month's counter value) when it arrives at the meter so that it and/or the meter can compare the new sequence number to the one that was established during last month's visit.

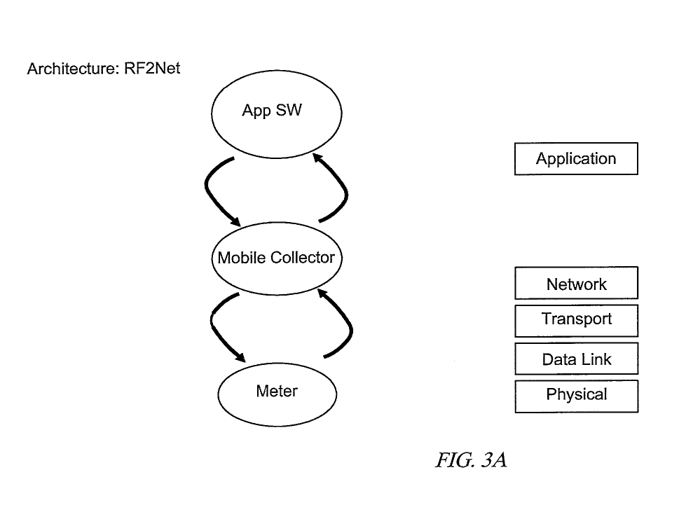

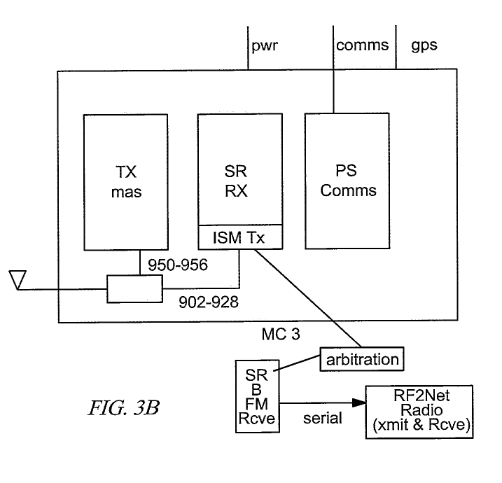

FIGS. 3A and 3B show scenarios under an “RF2Net” protocol. With this implementation, a multiplicity of electric meters with data storage, such as ANSI C12-19 registers, store reading data and contain a clock to maintain time and a radio system to communicate with collectors are employed, as is a radio-based mobile collection system that consists of a computer, GPS, mapping and meter reading software and radio receivers and transceivers that communicate with the meters. The RF2Net protocol shown in this example implementation supports both mesh networking (Synchronized mode) and mobile (Non-synchronized mode).

Under this embodiment, the radio based mobile collection system waits for a beacon from the meter/endpoint, which is sent every 2 seconds. Once the beacon is received, the mobile collection system sends a beacon on the same frequency (the non-synchronized endpoint listens for 2 seconds on the same channel as the previously sent beacon). The endpoint synchronizes itself to the mobile collection systems.

Then two-way communications transpire as shown in FIGS. 3A and 3B as follows:
Application layer—manages (limit) load on link;
Network layer—encryption;
Transport layer—MC would get multiple format messages (legacy) & new;
Physical layer—52 channels 500 Khz chis; 19 khz dev; 19.2 kbps; +24 dbm Communications between App SW, Mobile Collector and Meter transpire as follows:
App SW to Mobile Collector—Meter Specific RQST by Route IDs (E, G, W); Attributes: TOU Register Values; Reset demand
Mobile Collector to Meter—Send time; determine what cmd to send; parse return to validate read; use C12.19 message; Preload SR with module read request & what should be done; Handle new route recvd; comm w radio; each meter should require security keys from a key table updated at random frequency; headend would manage security keys
Meter—EPSEM C12xx STD Format Reqst; Demand Rqst; Time Sync; Demand RST; C12.19 Tables; New C12.22; GW comm. Module
Meter to Mobile Collector—Bill/Rgstr data; CMD ACK; EPSEM (Response)

FCC regulations may require that the channel must be changed every 400 ms maximum. If there are retries of two-way communications due to collisions or other problems, multiple channels may be used because a 400 ms time limit may otherwise be exceeded. In the case of a collision or other problem, the message is repeated once on the same channel, and if no answer, a second time, on an alternate channel. This avoids the problem of the mobile collector not knowing if the endpoint has switched off channel or not.

For the MAC layer, exchanged messages are seen as data messages; requests (Request Monthly Data for example) are contained in the body of the frame (and more particularly in the C12.22 protocol of the API layer). So each message contains an FCS field (forward error correction (FEC) and cyclic redundancy check (CRC)). But the header does not contain the same information as in the network mode. For example, a bit at the beginning of the MAC header may identify a Drive-By Mode frame.

Messages from the drive-by unit/collector to meters should be acknowledged, so that the collector can manage retransmissions. To save time, acknowledgement information may be included in the header of the next message from the meter. In the case where it is not included, a simple ACK message is sent after a timeout. If the collector does not receive the ACK (included or in a message) after the timeout, it repeats the message. In the other side, the collector does not acknowledge messages from the meter.

### Drive-By Mode Process

After the collector receives a beacon, it transmits a message to the meter that contains:
The channel that the endpoint has to switch to.
The request contained in the body of the frame, which is passed from the MAC up to the API to decode.

Once the endpoint receives a valid message from the collector, it sets a timer after when it will return in the non-synchronized mode, it asks a Physical layer to change frequency according a channel number indicated by the collector, it sets a timer to send a MAC ACK to the collector, and it gives the message to the API layer (via an LLC layer).

A few milliseconds later, the API layer (via the LLC) will normally ask the MAC layer to send the response. The MAC layer will send the acknowledgment of the previous message in the header of the response.

If an Ack timer ends before response from the API layer, an ACK will be sent alone.

If messages are lost due to collisions, the endpoint has nothing to do: It is the collector that will proceed to retry.

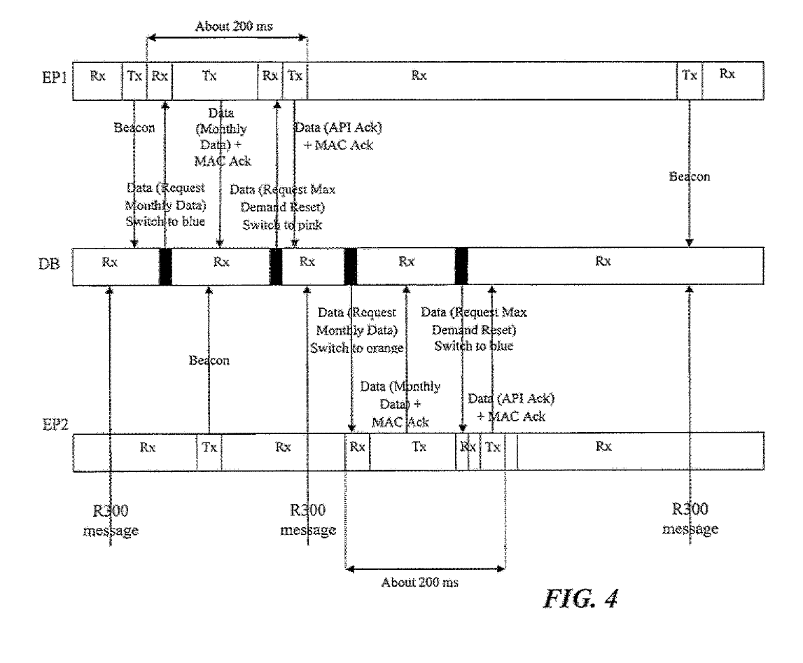

If there is no message from the collector for a few seconds, the Drive-By timer ends and the meter returns in non-synchronized mode. See FIG. 4.

The collector or MC (mobile collector) will read orphans of the network, that is to say non-synchronized endpoints. The collector or MC is already used for the reading of R300 meters, manufactured by Itron, Inc. of Spokane, Wash., and has to keep this functionality. Moreover the drive by unit has the possibility to read endpoints, which are already synchronized with the network and without disturbing it.
R300 meters randomly send their data every 4 seconds on a random channel.

The collector catches their data during driving (since the collector is often installed in a van or other vehicle). If a meter hasn't been read on the way by the van, adaptive software modifies the roadmap of the employee to pass again near the unread meter.
Non-Synchronized 2-way meters: these endpoints cannot establish a link (or not all the time) with the endpoint and data cannot be collected. The only way to reach them is to go near them with the collector. Two types of operation must be done:
   Once a month: the collector, without parking, has to read the monthly data of the unit, resynchronize its clock and reset the maximum demand value. The same actions are done every month.
   Occasionally: the collector downloads to the meter a more important quantity of data, like tariff grids or firmware updates. This exchange of data can be diverse and in the two directions (DB→EP, EP→DB).
Synchronized 2-way meters: if these endpoints are already in the network, every kind of operations can already be managed from the concentrator.

### I. Drive By Unit

The collector is a powerful vehicle-installed device already used in the field for reading residential meters. For the moment, the device is only a receiver that collects 1-way meter data. The system has been designed for collecting data at a speed of 45 miles/hour, i.e. 20 meters/s. As meters transmit periodically (e.g. every (4+Δt) seconds) on a random channel, the receiver is sophisticated. The receiver receives the entire ISM band, detects energy of the transmitted preambles, isolates them and can receive simultaneously up to 8 messages on different channels. A transmitter section includes a half-duplex architecture, which means that when the collector transmits, it cannot receive anything. So when the drive-by unit transmits messages to the 2-way meters, it can't receive the R300 data. The less the collector transmits, the less the R300 data collection will be disturbed.

### II. Process

Transmission from the collector has to be reduced to a minimum. It is hard to manage full communications with endpoints with a half-duplex architecture and in a small time (20 m/s). Moreover most of communications will happen occasionally.

Two coexisting processes are proposed:
For monthly operations on non-synchronized meters, a simple process based on requests and answers during the R300 data collection (without parking).
For occasionally operations on both non-synchronized and synchronized meters, a Park & Wait mode, where the collector emulates the behavior of a regular endpoint.

a. Park & Wait Mode

The Park & Wait mode is used to do some occasional operations on both non-synchronized meters and synchronized meters. The drive by unit may park near the meter and emulate a regular meter. During this mode collection of R300 meters may not be possible.
If the meter is still synchronized with the network, the drive-by awaits an endpoint beacon or another type of messages. If there is no traffic, the maximum time to wait is a beacon periodicity (not fixed, between 30 s and 2 minutes). It has almost 100% chance to catch it, because the drive-by can listen on all channels simultaneously. Then the drive-by unit synchronizes itself on the network (time slot, channels sequence, etc.), and sends what it wants to the endpoint, as a regular endpoint. This process takes up to a few minutes.
If the meter is not synchronized (orphans), it is almost the same. The collector awaits a beacon, which is sent every 2 seconds. Once the beacon received, the collector sends a beacon in the adequate frequency (the non-synchronized endpoint listens while 2 seconds on the same channel than the previous sent beacon). The endpoint believes that it has received a message from a synchronized endpoint, and synchronizes itself on the drive-by. Then all communications are possible.

To sum up, to communicate with:
A synchronized endpoint, the drive-by unit emulates an endpoint with a lower level.
A non-synchronized endpoint, the drive-by unit emulates a concentrator.

If other endpoints try to synchronize with the drive-by unit, the drive-by has the possibility to refuse the synchronization. Note that while the R300 meter is used as an example, other meters may of course be used.

b. Non-Synchronized Data Collection

A task of the collector remains to read monthly data and to reset/adjust some values of non-synchronized endpoints (orphans). These operations are repetitive and can be done while collecting R300 meters. A polling mechanism is used, where the master is the collector, and the non-synchronized meters are the slaves. A non-synchronized endpoint sends a short message (beacon) about every 2 seconds on a random channel and between transmissions, it listens on the same channel as the previous transmissions. So the collector has just to send some specific requests once it receives the endpoint's beacon. In the drive-by request, the drive-by unit indicates to the endpoint on which channel it has to switch to send responses and listen to next requests. The endpoint answers immediately, without attending to repetitions, collisions and so on. The collector will manage repetitions. Once the collector has finished with one endpoint, it polls another.

The two operations, which are normally done, read monthly data and reset maximum demand, take less than 200 ms per endpoint (monthly data=255 bytes with headers, transmissions @19.2 kbps). While requesting an endpoint, during reception phases, the drive-by unit can go on listening to R300 messages and other beacons. But with this process it can read only one 2-way meter at once. It has been established that the collector is in the range of an endpoint for 20 seconds (RF range=200 m, 20 m/s), in average. So the drive-by unit can read up to (20 s)/(0.2 s)=100 orphans (if no collisions) in the same cluster. It can be assumed that for a cluster of this size, a concentrator should have been installed, and a fixed network established.

FCC regulations require that the channel must change every 400 ms maximum. If there are repetitions due to collisions, this time can be easily exceed, thus the use of only one channel. The problem is if a collision occurs, the collector won't know if the endpoint has switched channels or not. This issue is solved by repeating the message once on the same channel, and if no answer, the second time, on the asked channel (there are only two choices).

For MAC layer the exchanging messages are seen as Data message, the requests (Request Monthly Data for example) are contained in the body of the frame (and more particularly in the C12.22 protocol of the API layer). So each message contains a FCS field (FEC+CRC). But as the header doesn't contain the same information as in the network mode, a bit at the beginning of the MAC header identify the Drive-By Mode frame.

Messages from drive-by unit to non-synchronized meters have to be acknowledged, so that the drive-by unit can manage repetitions. To save time, acknowledgement information is included in the header of the next message from the meter. In the case there is not, a simple ACK message is sent after a timeout. If the drive-by unit doesn't receive the ACK (included or not in another message) after the timeout, it repeats the message. In the other side, the drive-by doesn't acknowledge messages from the meter.

The MAC header for these operations has been reduced to decrease transmit time of the collector, and less affect the R300 data collection.

For a cluster of 10 orphans (it is assumed that for more, a concentrator has been installed):

$$Endpoint Rate = \frac{NbEndpointRate}{\frac{DistanceInRange}{Speed}} = \frac{10}{\frac{200 * 2}{20}} = 0.5 \frac{Endpoint}{s}$$

With headers, transmitted requests of the drive-by size of about 60 bytes each one, and there are two requests by endpoints. Assuming two tries per endpoint, it gives:

DataRate=RequestSize*NbOβtequests*NbOjTries*EndpointRate=60*2*2*0.5=120 Bytes

At 19.2 kbps, the transmit duty cycle of the drive-by is:

$$TxDutyCycle = \frac{DataRate}{TransmitterRate} = \frac{120}{19200 / 8} = 5 \%$$

It has been computed that the redundancy of received R300 messages is 2 times. The probability of missing R300 messages while collecting this cluster of RF2Net orphans is:

Probability=0.052=0.25%

The probability is low, but exists in what can be considered a worst case. But the collector can manage and correct this situation by providing an indication to the driver for passing near the unread meters a second time.

FIG. 4 shows message exchange between a mobile collector and two end points EP1 and EP2.

### III. Drive-By MAC Header

TABLE 1
Drive-By MAC Frame

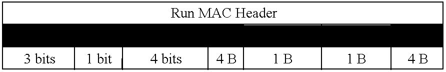

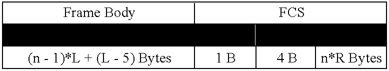

Revision: It indicates the version of the protocol.
D-By: This bit indicates if it is a Run (set) MAC header or a Mesh MAC Header (clear).
Frame Type: This bit indicates the type of the frame.

TABLE 2
MAC Frame Type

| | | | |
|---|---|---|---|
| 0000 | ACK | 1000 | Reserved |
| 0001 | Data | 1001 | Reserved |
| 0010 | Reserved | 1010 | Reserved |
| 0011 | Reserved | 1011 | Reserved |
| 0100 | Reserved | 1100 | Reserved |
| 0101 | Reserved | 1101 | Reserved |
| 0110 | Reserved | 1110 | Reserved |
| 0111 | Reserved | 1111 | Reserved |

ACK Message only contains acknowledgment information of the latest received frame. Only the meter sends this message, and in the case it has no Data to send.
Data messages are messages that concern upper layers, e.g., in the drive-by mode, almost every message. Ack information is contained in Data message from the meter.

ID:

This field is 4 bytes long. It is the ID of the non-synchronized meter that communicates with the collector.

Frame ID:

If the frame is from D-B to meter, the field is equal to the frame number that is acknowledged. Else if the frame is from meter to D-B, this field is equal to the MAC frame number.

Channel:

For the drive unit, this field is used to command the next channel that the destination endpoint must use.

For the endpoint, this field indicates which channel it is using.

CRC:

These 4 bytes are allocated for a CRC-32 value to check the integrity of the MAC header. This header is important because it contains synchronization information.

### IV. Drive-By Mode Process

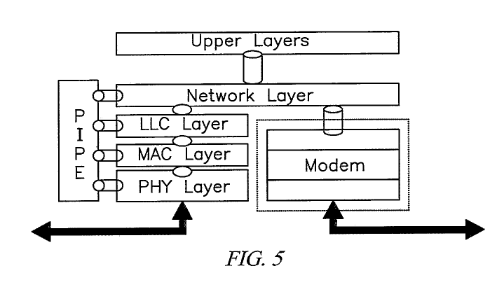

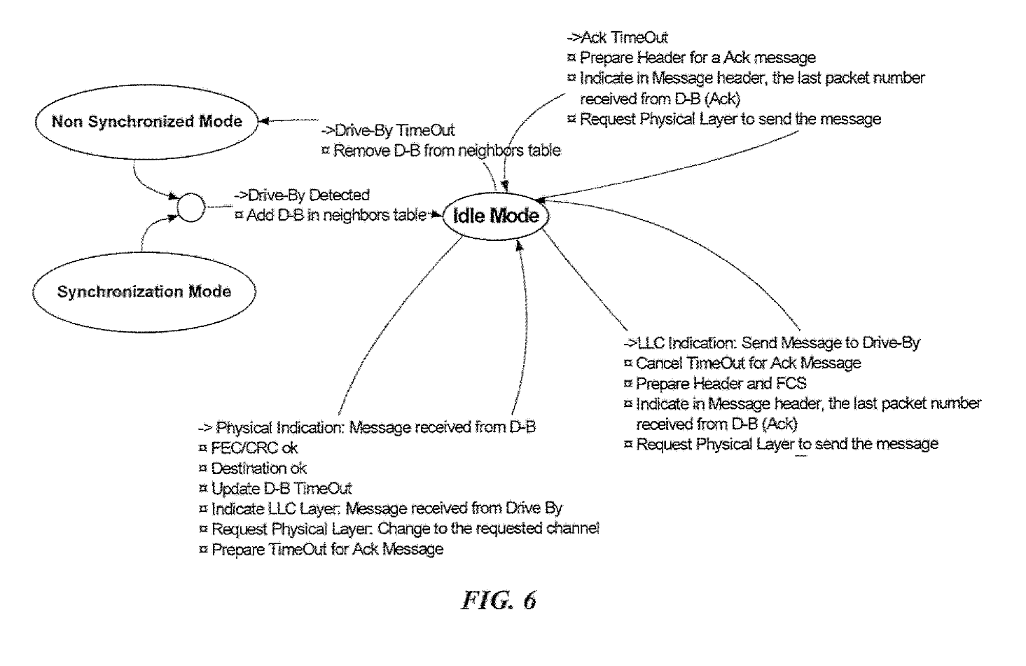

See FIGS. 5 and 6. The Drive-By mode is used to proceed with simple actions on meters that cannot be connected to the network (orphans).

If the endpoint is in Non Synchronized Mode or in Synchronized Mode, it directly goes into drive-by mode when identifying drive-by frames. Messages received by the endpoint contain:
The channel that the endpoint has to switch to.
The drive-by request contained in the body of the frame, only the API layer is able to decode it. From the MAC point of view, this message is seen as a classic Data message

Once the endpoint receives a valid message from the Collector, it sets a timer after when it will return to non-synchronized mode, it asks the Physical layer to change frequency according the channel number indicated by the Drive-By, it sets a timer to send a MAC ACK to the Drive-By, and gives the message to the API layer, via the LLC layer.

A few ms later, the API layer (via the LLC) will normally ask the MAC layer to send the response. The MAC layer will send acknowledgment of the previous message in the header of the response.

If the Ack timer ends before response from the API layer, the Ack will be sent alone.

If messages are lost due to collisions, the endpoint has nothing to do: It is the Collector that will proceed to the repetition.

If there are no messages from the Drive-By for a few seconds, the Drive-By timer ends and the meter returns to non-synchronized mode.

In general, the detailed description of embodiments of the present subject matter is not intended to be exhaustive or to limit the subject matter to the precise form disclosed above. While specific embodiments of, and examples for, the subject matter are described above for illustrative purposes, various equivalent modifications are possible within the scope of the subject matter, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of such processes or blocks may be implemented in a variety of different ways. Also, while processes or blocks are at times shown as being performed in series, such processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the present subject matter reside on a server computer, while corresponding portions reside on a client computer such as a mobile or portable device, and thus, while certain hardware platforms are described herein, aspects of the subject matter are equally applicable to nodes on a network.

The teachings of the subject matter provided herein can be applied to other systems, not necessarily the system described herein. The elements and acts of the various embodiments described herein can be combined to provide further embodiments.

While the above description details certain embodiments of the present subject matter and describes the best mode contemplated, no matter how detailed the above appears in text, the subject matter can be practiced in many ways. Details may vary considerably in implementation details, while still being encompassed by the subject matter disclosed herein. In general, the terms used in the following claims should not be construed to limit the subject matter to the specific embodiments disclosed in the specification, unless the above Detailed Description section explicitly defines such terms. Accordingly, the actual scope of the present subject matter encompasses not only the disclosed embodiments, but also all equivalent ways of practicing or implementing such present subject matter

1. In an automatic meter reading system comprising at least one reader and a plurality of endpoints, each of the endpoints adapted to conduct radio frequency communication with one of the at least one reader on a bubble-up basis in a one-way mode, and in a selectively-initiated two-way mode, a method of assessing or predicting communication reliability, the method comprising:
receiving a message transmitted between a first reader and a first endpoint;
measuring a received signal strength indication (RSSI) of the message; and
making a decision affecting future communication between the first reader and the first endpoint based on the measured RSSI.

2. The method of claim 1, wherein the step of receiving the message includes either receiving the message from the first endpoint by the first reader, or receiving the message from the first reader by the first endpoint.

3. The method of claim 1, wherein the step of receiving the message includes receiving the message in the one-way mode or in the two-way mode.

4. The method of claim 1, wherein the step of making the decision affecting future communication between the first reader and the first endpoint includes foregoing initiating or continuing two-way communications.

5. The method of claim 1, wherein the step of making the decision affecting future communication between the first reader and the first endpoint includes adjusting an instruction specifying a request for certain data to be transmitted in the two-way mode.

6. The method of claim 1, wherein the step of making the decision affecting future communication between the first reader and the first endpoint includes transmitting a command in two-way mode to change channels.

7. The method of claim 1, wherein the step of making the decision affecting future communication between the first reader and the first endpoint includes changing a mobile collection route or schedule.

8. The method of claim 1, wherein the step of making the decision affecting future communication between the first reader and the first endpoint includes assigning the first endpoint to a second, different, reader.

9. The method of claim 1, wherein the step of making the decision affecting future communication between the first reader and the first endpoint includes instructing the first endpoint to increase transmission power level.

10. The method of claim 1, further comprising the steps of:
logging RSSI values associated with certain communications; and
analyzing the logged RSSI values to identify a potential trend or characteristic of a communication arrangement between the first reader and the first endpoint.

11. In an automatic meter reading system comprising a reader and a plurality of endpoints, each of the endpoints adapted to conduct radio frequency communication with the reader on a bubble-up basis, a method of improving communication reliability, the method comprising:
receiving, by the reader, a first message transmitted by a first endpoint at a first frequency;
determining, by the reader, whether the first frequency is suitably centered within a predefined communication channel associated with the first message;
initiating two-way communication between the reader the first endpoint; and
during the two-way communication, sending an instruction to the endpoint from the reader, wherein the instruction specifies a frequency correction for the endpoint to implement.

12. In an automatic meter reading system comprising at least one reader and a plurality of endpoints, each of the endpoints adapted to conduct radio frequency communication with one of the at least one reader on a bubble-up basis in a one-way mode, and in a selectively-initiated two-way mode, a method of assessing or predicting communication reliability, the method comprising:
measuring channel clarity; and
making a decision affecting future communication between a first reader and a first endpoint based on the measured channel clarity.

13. In an automatic meter reading system that includes a reader and a plurality of endpoints, each of the plurality of endpoints adapted to conduct radio frequency communication with the reader, a method of conducting communications, the method comprising the steps of:
initiating, by the plurality of endpoints, a communication session with the reader via an initial one-way communication comprising an identification beacon of the endpoint; and
selectively initiating, by the reader, two-way communication with individual ones of the plurality of endpoints in response to receipt of an initial one-way communication from each of such endpoints.

14. The method of claim 13, further comprising the step of automatically synchronizing with the reader communication activity of each of the individual ones of the plurality of endpoints with which the reader selectively communicates in two-way mode.

15. The method of claim 13, further including:
selectively transmitting from the reader to an endpoint an instruction that includes a command requesting a set of consumption information from such endpoint; and
operating such endpoint to respond to such command by transmitting a message that includes the requested consumption information.

16. The method of claim 13, further including maintaining a database by the reader, the database including endpoint-specific information associated with each of the plurality of endpoints.

17. The method of claim 13, further comprising simultaneously receiving two-way communications from endpoints transmitting on different channels.

18. The method of claim 13, further including configuring such reader to selectively transmit commands to an endpoint, selected from: a command to send time of use data, a command to send consumption data, and a command to reset registers.

19. The method of claim 13, wherein:
such plurality of endpoints comprise a respective plurality of electric meters with respective data storage registers for storing consumption data, respective clocks to maintain time, and respective radio systems for communication with such reader;
wherein such reader includes a computer, GPS, mapping and meter reading software and radio receivers and transceivers for communicating with such meters; and
such meters and such reader are collectively capable of operating both in synchronized and non-synchronized modes.

20. The method of claim 19, wherein:
such meters respectively transmit a meter beacon signal periodically and thereafter listen for a preset period of time on the same frequency as the previously sent meter beacon signal; and
such reader returns a reader beacon signal on the same frequency.

21. The method of claim 19, wherein:
such meters respectively synchronize themselves with such reader upon respective receipt of such reader beacon signal; and
such meters respectively include acknowledgement information in the headers of subsequent messages from the meter once the meter is synchronized with such reader.

22. The method of claim 20, wherein:
such reader beacon signal includes a frequency channel assignment to which the respective meter is to switch; and
each respective meter upon receipt of such reader beacon signal sets a timer after which it will return to a non-synchronized mode.

23. The method of claim 19, wherein such reader automatically handles duplicative transmissions from such meters.

24. The method of claim 22, wherein such meters and such reader when conducting two-way communications in synchronized mode, addresses lost messages by repeating a message once on such assigned frequency channel, and if no answer, a second time on an alternate channel.

25. A mobile daily interval meter reading system, comprising:
an endpoint and a reader;
wherein said endpoint is capable of transmitting in either one-way or two-way RF communication mode, saves a plurality of intervals of utility meter data, and normally operates in a bubble-up mode using said one-way RF communication mode; and
wherein said reader listens for said endpoint in said bubble-up mode, and upon detecting said endpoint in said bubble-up mode, utilizes said two-way RF communication mode to transmit a command to said endpoint to send a specified number of intervals in response.

26. The system of claim 25, wherein said reader is configured to selectively transmit commands to said endpoint, selected from: a command to send time of use data, a command to send consumption data, and a command to reset registers.

27. The system of claim 25, further including:
a plurality of said endpoints, comprising a respective plurality of electric meters with respective data storage registers for storing consumption data, respective clocks to maintain time, and respective radio systems for communication with said reader; and
wherein said reader includes a computer, GPS, mapping and meter reading software and radio receivers and transceivers for communicating with said meters, said meters and said reader collectively capable of operating both in synchronized and non-synchronized modes.

28. The system of claim 27, wherein:
respectively said meters periodically transmit a meter beacon signal and thereafter listen for a preset period of time on the same frequency as the previously sent meter beacon signal; and
said reader returns a reader beacon signal on the same frequency.

29. The system of claim 27, wherein said meters respectively synchronize themselves with said reader upon respective receipt of said reader beacon signal.

30. The system of claim 29, wherein said meters respectively include acknowledgement information in the headers of subsequent messages from the meter once the meter is synchronized with said reader.

31. The system of claim 28, wherein:
said reader beacon signal includes a frequency channel assignment to which the respective meter is to switch; and
each respective meter upon receipt of said reader beacon signal sets a timer after which it will return to a non-synchronized mode.

32. The system of claim 27, wherein said reader includes multiple receivers able to simultaneously receive multiple frequencies from multiple meters.

33. The system of claim 27, wherein said reader automatically handles repetitive transmissions from said meters.

34. The system of claim 31, wherein said meters and said reader when conducting two-way communications in synchronized mode, addresses lost messages by repeating a message once on said assigned frequency channel, and if no answer, a second time on an alternate channel.
